(19) United States
(12) Patent Application Publication
(10) Pub. No.: US 2005/0083596 A1
(43) Pub. Date: Apr. 21, 2005

(54) Outside rear view mirror fixing structure for vehicle

(76) Inventor: Myung-Ky Jang, Ulsan Metropolitan City (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,233

(22) Filed: Dec. 30, 2003

(30) Foreign Application Priority Data
Oct. 16, 2003 (KR) 10-2003-0072070

(51) Int. Cl. G02B 7/182

(52) U.S. Cl. 359/879; 359/871

(57) ABSTRACT

An outside rear view mirror fixing structure for a vehicle has a clip integrally formed at a base cover is coupled to a clip fastening hole formed at a quadrant panel. Thus, temporarily fixing the outside rear view mirror to the quadrant panel and allowing the outside rear view mirror to be easily fixed to the quadrant panel, such that a tight coupling, between the clip and the clip fastening hole, can be obtained to prevent noise from entering the interior of a vehicle and maintain a noise-free interior.

### CROSS-REFERENCE TO RELATED APPLICATIONS

This application claims priority to Korean Application No. 10-2003-0072070, filed on Oct. 16, 2003, the disclosure of which is incorporated fully herein by reference.

### FIELD OF THE INVENTION

Generally, the present invention relates to an outside rear view mirror of a vehicle. More particularly, a structure for fixing an outside rear view mirror to a quadrant panel formed at the front of an inner front door panel of a vehicle.

### BACKGROUND OF THE INVENTION

Conventional outside rear view mirrors for vehicles are structured in a way that a mirror housing is hinged to a base. The base is in turn fixed to a quadrant formed toward the front of an inner front door panel. The outside rear view mirror increasingly becomes heavier because supplementary functions are added thereto to prevent trembling of parts when a vehicle is moving. A folding function of the outside rear view mirror is also added which further increases the weight thereof. Accordingly, the outside rear view mirrors often become loose and may fail.

### SUMMARY OF THE INVENTION

The present invention provides an outside rear view mirror fixing structure for a vehicle configured to mount a heavy outside rear view mirror in a simple structure, thereby improving the manufacturing process and reducing the manufacturing cost.

In accordance with a preferred embodiment of the present invention, the outside rear view mirror fixing structure comprises a base hinged to a mirror housing and formed with a plurality of female screws. A base cover encompasses an external side of the base. A quadrant panel is formed with a plurality of bolt fastening holes at positions corresponding to the plurality of female screws and are provided with a clip fastening hole. A clip is integrally formed at a position corresponding to the clip fastening hole of the base cover to provisionally fix the base to the quadrant panel.

### BRIEF DESCRIPTION OF THE DRAWINGS

For a better understanding of the nature and objects of the present invention, reference should be made to the following detailed description, read in conjunction with the accompanying drawings, in which:

FIG. 1 is an exploded perspective view illustrating an embodiment of the present invention; and

FIG. 2 is a cross-sectional view taken along line II-II of FIG. 1 illustrating a coupled state of the embodiment of the present invention.

### DETAILED DESCRIPTION OF PREFERRED EMBODIMENTS

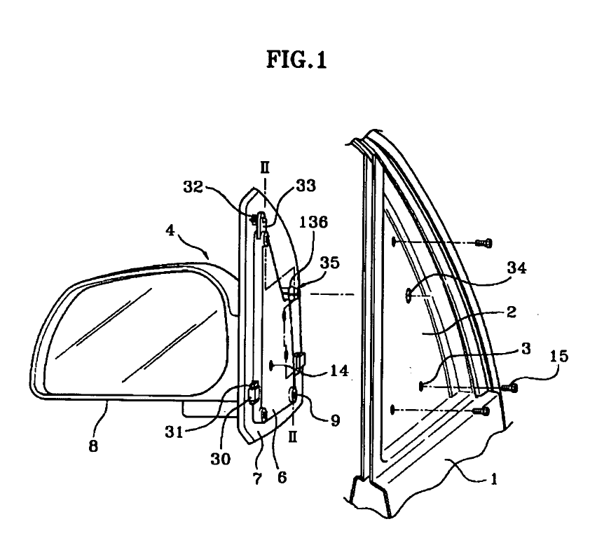

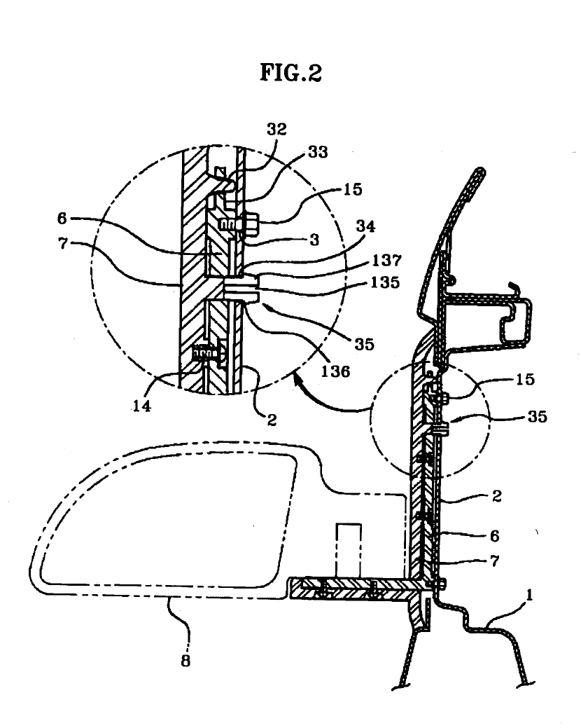

As shown in FIGS. 1 and 2, a mirror housing 8 is hinged to a base 6, and the base 6 is externally covered by a base cover 7. When hitching lugs 30 are mounted at both lower sides of the base cover 7, a support lug 32 is formed at an upper side of the base cover 7. Hitching pieces 31 are formed at positions corresponding to those of the hitching lugs 30 of the base 6, a support piece 33 is formed at a position corresponding to that of the support lug 32 of the base 6, and the hitching pieces 31 are inserted into the hitching lugs 30. Furthermore, the support piece 33 supports the support lug 32 to be fixed by a screw 14, the base 6 of the base cover 7 is solidly coupled, and under this solid coupling state, virtually no noise is generated from the trembling of these parts when the vehicle is moving.

A quadrant panel 2 of an inner door panel 1 is formed with a clip fastening hole 34. The base cover 7 is integrally formed with a clip 35 when the base cover 7 is injection-molded. The clip 35 is preferably formed in soft plastic along with the base cover 7. The clip 35 is formed at a free end thereof with a hollow part 135 and is externally formed with a hitching jaw 136. The clip 35 is axially formed with a plurality of grooves 137, such that when the clip 35 is inserted into the clip fastening hole 34, a diameter of the hitching jaw 136 is narrowed to allow a fast insertion. When separation is to be effected, it can be rapidly carried out by changing the shape of the peripheral surface of the hitching jaw 136 to a center side thereof via a tool. The peripheral surface of the clip 35 is so formed as to have the same diameter as that of the clip fastening hole 34 to allow the clip 35 to be inserted into the clip fastening hole 34 in a fairly securable manner, such that the outside rear view mirror 4 can be temporarily fixed to the quadrant panel 2.

Under the temporary fixing state, an operator does not need to support the outside rear view mirror 4 by hand, and instead, the base 7 can be fixed to the quadrant panel 2 by several bolting jobs for fixing the bolt fastening hole 3 and the female screw via a bolt 15 for completion of the assembly. In a structure where the clip 35 and the clip fastening hole 34 are used for temporarily fixing the base cover 7 to the quadrant panel 2, the peripheral surface of the clip 35 and the diameter of the clip fastening hole 34 are formed in the same size to thereby be closely abutted therebetween, such that noise cannot be introduced into the interior of a vehicle through the clip 35 and the clip fastening hole 34.

Of course, in the structure where the clip 35 and the clip fastening hole 34 are employed, a tool is used to easily separate the clip 35 from the clip fastening hole 34, such that it is also easy to separate the outside rear view mirror 4 from the quadrant panel 2.

As apparent from the foregoing, there is an advantage in the outside rear view mirror fixing structure for vehicle thus described according to the embodiment of the present invention in that a clip integrally formed at a base cover is coupled to a clip fastening hole formed at a quadrant panel to temporarily fix the outside rear view mirror to the quadrant panel, thereby allowing the outside rear view mirror to be easily fixed to the quadrant panel, whereby a tight coupling state between the clip and the clip fastening hole can be obtained to prevent noise from entering the interior of a vehicle and maintain a noise-free interior. There is another advantage in that the structure is simple such that the number of work processes can be reduced to contribute to a reduction in manufacturing costs.

1. An outside rear view mirror fixing structure for a vehicle comprising:
a base hinged to a mirror housing and formed with a plurality of female screws;
a base cover encompassing an external side of the base;
a quadrant panel formed with a plurality of bolt fastening holes at positions corresponding to said plurality of female screws and equipped with a clip fastening hole;
a clip integrally formed at a position corresponding to said clip fastening hole of said base cover to provisionally fix said base to said quadrant panel.

2. The structure as defined in claim 1, wherein said clip is formed at a free end thereof with a hollow part and is externally formed with a hitching jaw and is axially formed with a plurality of grooves.

3. The structure as defined in claim 2, wherein a peripheral surface of said clip is so formed as to have the same diameter as that of said clip fastening hole.

4. The structure as defined in claim 3, wherein said clip is made of soft plastic.

5. An outside rear view mirror fixing structure for a vehicle comprising:
a base hinged to a mirror housing configured and dimensioned with a coupling;
a base cover encompassing an external side of the base;
a fastening hole positioned corresponding to said coupling and equipped with a clip fastening hole; and
a clip positioned corresponding to said clip fastening hole of said base cover to provisionally fix said base at said fastening hole.
